(19) United States
(12) Patent Application Publication
(10) Pub. No.: US 2009/0191476 A1
(43) Pub. Date: Jul. 30, 2009

(54) THERMOPLASTIC MATERIALS COMPRISING CHARGE TRANSFER AGENTS AND PHOTO ACID GENERATING AGENTS

(76) Inventors: Neil John Rogers, Vilvoorde (BE); Christopher Lamb, Ohain (BE); Anthony Nicholas Jarvis, Widnes Cheshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/357,680

(22) Filed: Jan. 22, 2009

(30) Foreign Application Priority Data
Jan. 25, 2008 (EP) 08150652.9
Apr. 8, 2008 (EP) 08154232.6

(51) Int. Cl. G03G 5/04; G03G 13/06

(52) U.S. Cl. 430/76; 430/56; 430/84; 430/96; 430/97

(57) ABSTRACT

The present invention relates to a thermoplastic material comprising polymer, at least one charge transfer agent, wherein the charge transfer agent is substantially colourless when neutral, but which develops colour when a charge is acquired, and at least one photo acid generating agent. The present invention further relates to a method of processing thermoplastic material to form a plastic article, wherein the method comprises the step of processing the thermoplastic material at a temperature greater than the melt temperature, Tₘ, of the thermoplastic, wherein the thermoplastic material comprises polymer and at least one charge transfer agent, wherein the charge transfer agent is substantially colourless when neutral, but which develops colour when a charge is acquired, and at least one photo acid generating agent, and wherein the method further comprising the step of irradiating the plastic article to colour at least a region of the plastic article.

### FIELD OF THE INVENTION

The present invention relates to thermoplastic materials comprising polymer, at least one charge transfer agent and at least one photo acid generating agent. The present invention further relates to methods of processing thermoplastic material comprising polymer, the charge transfer agent and the photo acid generating agent, at elevated temperatures, above the melt temperature of the thermoplastic material, to form plastic articles such as containers, especially packaging containers such as bottles.

### BACKGROUND OF THE INVENTION

Charge transfer agents are compounds that are colourless or of low colour when neutral but develop colour when they acquire a charge. These compounds may be used in combination with an acid generating species which can be either thermally or photolytically initiated or both. Suitable examples include those taught in WO2006/051309, published on May 18, 2006, and WO2007/063339, published on Jun. 7, 2007, both of which disclose the use of acid generating agents applied to substrates such as plastic films.

It would, however, be desirable to disperse charge transfer agents and photo acid generating agents in a thermoplastic material, and then to form finished plastic articles by, for example, blow molding, injection molding, extruding. One advantage of achieving such plastic articles would be in the packaging of goods, such as consumer goods, in containers such that any data, colour coding and the like can be inscribed into a bottle or closure late in the packing process, at or even after the packing line. This avoids the need for feeding numerous different bottles and/or closures to a packing line for product change-overs, thus reducing packaging inventory and improving packing efficiency.

The processes of forming finished plastic articles from thermoplastic materials are typically carried out at elevated temperatures at which the thermoplastic materials are readily deformable. However it has been discovered that many photo acid generating agents are chemically unstable, or physically unstable in the context of the thermoplastic materials, at these elevated temperatures.

### SUMMARY OF THE INVENTION

The present invention relates to a thermoplastic material comprising polymer, at least one charge transfer agent, wherein the charge transfer agent is substantially colourless when neutral, but which develops colour when a charge is acquired, and at least one photo acid generating agent.

The present invention further relates to a method of processing thermoplastic material to form a plastic article, wherein the method comprises the step of processing the thermoplastic material at a temperature greater than the melt temperature, Tₘ, of the thermoplastic, wherein the thermoplastic material comprises polymer and at least one charge transfer agent, wherein the charge transfer agent is substantially colourless when neutral, but which develops colour when a charge is acquired, and at least one photo acid generating agent, and wherein the method further comprising the step of irradiating the plastic article to colour at least a region of the plastic article.

### DETAILED DESCRIPTION OF THE INVENTION

Photo acid generating compounds useful in the present invention are preferably photo acid generating species that are heat stable and act via a photolytic mechanism. These compounds are preferably selected from the group consisting of ‘onium’ compounds, triazine, phthalimide, naphthalimide and carboximide compounds.

“Onium” compounds are defined in IUPAC Compendium of Chemical Technology, electronic version, http://goldbook.iupac.org/O04291.html. Suitable onium compounds include sulphonium (H₃S⁺) and iodonium (H₂I⁺) compounds. Preferred onium salts are perfluoro-1-butanesulfonate, p-toluenesulfonate 9,10-dimethoxyanthracene-2-sulfonate, nitrate, triflate and hexafluorophosphate salts of iodonium and sulphonium compounds. Particularly preferred are triflate and hexafluorophosphate salts.

Other examples of photo acid generators are given in the Sigma-Aldrich ‘Products for Material Science’ catalogue and are taken from the lithography/nanopatterning industries. Particularly preferred examples of acid generating agents are triarylsulphonium hexafluorophosphate salts mixed in propylene carbonate, and 1-Naphthyl diphenyl sulphonium triflate.

The photo acid generating agents are used in the present invention in combination with a charge transfer agent (CTA).

Charge transfer agents are examples of polychromic substances, i.e. compounds that undergo colour change reactions on irradiation. The charge transfer agents used in this invention are compounds that are substantially colourless when neutral, but develop colour when they acquire a charge. Preferred charge transfer agents include a heteroatom selected from N, O and S, and an aromatic group conjugated thereto. For example, suitable charge transfer agents may be of the formula Ar₁—X—Ar₂, wherein each Ar is an aromatic group such as a benzene ring (unsubstituted or substituted) and X is the heteroatom. The Ar groups may be linked so that X is part of a further ring. An indole system may be preferred. Typically these compounds are nitrogen comprising bases that when protonated form coloured compounds. If X is N, it will usually be further substituted by an alkyl or aromatic (but not necessarily vinylic) group, i.e. the compound is a tertiary amine which, when protonated, allows the positive charge to be delocalised. Preferred examples of charge transfer agents are amines, carbazoles and leuco dyes.

Specific examples of charge transfer agents which are amines or carbazoles include triphenylamine, diphenylamine, 1,2-diphenylindole, dibenzothiophene, dibenzofuran, carbazole, N-ethyl carbazole, N-phenyl carbazole, N-hydroxyethyl carbazole.

Suitable leuco dyes are described in “Dyestuffs and Chemicals for Carbonless Copy Paper” presented at Coating Conference (1983, San Francisco, Calif. pp 157-165) by Dyestuffs and Chemicals Division of Ciba-Geigy Corp Greenboro, N.C. Leuco dyes are understood to be colourless in neutral or alkaline media, but become coloured when they react with an acidic or electron accepting substance. Suitable examples include compounds such as triphenylmethanephthalide compounds, azaphthalide compounds, isoindolide phthalide compounds, vinylphthalide compounds, spiropyran compounds, rhodamine lactam compounds, lactone and dilactone compounds, benzoyl leuco methylene blue (BLMB), derivatives of bis-(p-di-alkylaminoaryl) methane, xanthenes, indolyls, auramines, chromenoindol compounds, pyrollo-pyrrole compounds, fluorene compounds, and fluoran and bisfluoran compounds, with fluoran compounds being preferred. Particularly preferred commercial leuco dye products include the Pergascript range by Ciba Speciality Chemicals, Basel, Switzerland and those by Yamada Chemical Co. Ltd, Kyoto, Japan. Others include those made by Nisso Chemical Co GmbH a subsidiary of Nippon Soda Co. Ltd. Tokyo, Japan.

The charge transfer agent and the photo acid generating agent of the present in invention are mixed with a polymer to form a thermoplastic material. The thermoplastic material can further comprise any other additives known to those skilled in the art such as binders, pigments, dyes, resins, lubricants, solubilizers, particulate matter, fluorescers, and the like. Particularly preferred are opacifying agents such as titanium dioxide, pearlescent pigments and fluorescent agents. Radiation absorbers can also be used. Exposure of the thermoplastic material comprising the charge transfer agent compounds and the photo acid generating agent of the present invention to irradiation will bring about a colour change reaction which can be used to create text, artwork, devices or other images and effects.

Examples of the thermoplastic materials into which the charge transfer agents of the present invention can be incorporated into are: Acrylonitrile butadiene styrene (ABS), Acrylic, Celluloid, Cellulose acetate, Ethylene-Vinyl Acetate (EVA), Ethylene vinyl alcohol (EVAL), Fluoroplastics (PTFEs, including FEP, PFA, CTFE, ECTFE, ETFE), Ionomers, Kydex, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polyethylene terephthalate (PET), Polycyclohexylene dimethylene terephthalate (PCT), Polycarbonate (PC), Polyhydroxyalkanoates (PHAs), Polyketone (PK), Polyester, Polyethylene (PE) including low density (LDPE) and high density (HDPE) versions, Polyetheretherketone (PEEK), Polyetherimide (PEI), Polyethersulfone (PES)—see Polysulfone, Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polypropylene (PP), Polystyrene (PS), Polysulfone (PSU), Polyvinyl chloride (PVC), Polyvinylidene chloride (PVDC), Spectralon. Most preferred are polyolefins, and in particular polyethylene, polyethylene terephthalate, polypropylene, or mixtures thereof.

Preferably the thermoplastic material of the present invention comprises:
from 80% to 99.98% by weight of the polymer;
from 0.01% to 10% by weight of the charge transfer agent; and
from 0.01% to 10% by weight of the photo acid generating agent; and
optionally other additives (such as those additives described herein).

The charge transfer agent, the photo acid generating agent and/or other substances of the present invention can be incorporated into the thermoplastic material using a solid or liquid masterbatch process. Suitable examples of these are supplied by Americhem Inc of Cuyahoga Falls, Ohio, USA, Hampton Colours of Stroud, UK, Riverdale Color of Perth Amboy, N.J., USA and ColorMatrix of Berea, Ohio, USA.

Thermoplastic materials may be formed into complex forms by various processes, notably molding processes, extrusion processes, etc. In these processes the thermoplastic material is typically heated to a temperature above its melt temperature, Tₘ, and preferably to a temperature between about 100° C. and about 500° C., so that the thermoplastic material can be formed into the desired shape. In molding processes a mold which generally comprises two or more parts is provided, which can be closed to form a mold cavity. In injection molding processes the thermoplastic material is injected into the mold cavity. In blow molding processes a heated preform or parison is placed within the mold and air is injected into the preform or parison so that it expands within the mold cavity to form a hollow body. In extrusion processes the heated thermoplastic material is forced under pressure through an extrusion die. Many variations on these basic processes are practiced in industry, such as, for example, injection stretch blow molding, extrusion blow molding.

The color-activatible thermoplastic resin can be used to make packages and articles of various forms such as produced by the non-limiting examples of: blow molding, extrusion blow molding, injection blow molding, stretch blow molding, injection stretch blow molding, injection molding, injection molding of preforms, overmolding, multi-layer injection molding, extrusion, plastic extrusion, sheet extrusion, film extrusion, coat-extrusion, overjacket extrusion, co-extrusion, compression molding, and thermoforming.

In one preferred process the thermoplastic material is first formed into fibres, for example by extrusion processes (commonly referred to as “spinning”). Spun fibres may be used to make cloth-like sheets of non-woven fibres, or by weaving, knitting, etc. Such woven or non-woven sheets comprising thermoplastic material as defined herein are “plastic articles” according to the present invention, and they can be further treated by the step of irradiating the sheet to colour at least a region of the sheet. In this way various effects including text, artwork, devices or other images and effects such as stripes, speckles can be achieved on woven or non-woven sheets.

In another preferred process, co-extrusion is used to form an article from two or more thermoplastics. Using a co-extrusion process enables the charge transfer agent to be incorporated into only one of the co-extruded layers, or into more than one, but not all of the co-extruded layers. This enables the method of the present invention to be achieved using less charge transfer agent than would be necessary if the charge transfer agent would be uniformly distributed throughout an single layer of the thermoplastic material, thus offering the opportunity of saving cost.

These processes are useful for the production of packaging and packaging elements which may be primary packaging, secondary packaging, and/or additional packaging. Exemplary packaging embodiments include plastic boxes, bags, pouches, cans, bottles, tottles, jars, thermoform blisters, clamshells, and combinations thereof. Primary packaging includes any container, including its closure, pump, cap, spout, handle, lid, cover, plastic film windows. Secondary packaging includes any additional materials that are associated with the primary packaging, such as, for example, a container such as a box or polymeric sleeve or wrapping/covering that at least partially surrounds, contains, or contacts the primary packaging. The color-activatible composition can also take the form of a label or other package element that can be affixed to the consumer product itself, advertisement material pertaining to the consumer product, and/or packaging of the consumer product. These packaging elements, comprising the charge transfer agent of the present invention are particularly suitable for use with fast moving consumer goods, such as home and personal care products, as any data can be inscribed on to the container or closure very late down stream. The compounds of the present invention can also yield colours without the need for multi-component mixtures and the user can choose which colour or shade they desire merely by controlling the irradiation. Exposure of the part comprising the charge transfer agent and the photo acid generating agent of the present invention to irradiation will bring about a colour change reaction which can be used to create text, artwork, devices or other images and effects such as stripes, speckles. Alternatively, or additionally, the charge transfer agent compounds may be selectively distributed, rather than homogeneously distributed, within the thermoplastic material in order to achieve the desired effects.

Surface effects can be used to compliment or enhance the colour effects generated by the present invention. Part or all of the surface of the coloured article can be embossed, roughened, contoured, for example.

The thermoplastic comprising the charge transfer agent and the photo acid generating agent of the present invention, and/or other substances, can further comprise other additives known to those skilled in the art of thermoplastic processing. Particularly preferred are opacifying agents such as titanium dioxide, pearlescent pigments and fluorescent agents, and radiation absorbers such as UV and NIR absorbers. Other additives include reheat agents, slip additives, antioxidants, light and heat stabilizers, metal deactivators, PVC stabilizers, plasticizers, lubricants, PVC processing aids, impact modifiers, flame retardants, antistatic agents, fluorescent whitening agents, biostabilizers, antimicrobials, chemical blowing agents, organic peroxides nucleating agents, anti acetaldehyde agents, oxygen barriers, carbon dioxide barriers, process aids, stabilizers and HALS.

### EXAMPLES

### Example 1

### Application of Carbazole Type CTA to a Thermoplastic Using an Injection Moulding Process

Hastalen ACP5831 D polyethylene (150 g) was mixed with N-ethyl carbazole (1.5 g) and triarylsulphonium hexafluorophosphate salts (50%) mixed in propylene carbonate (2.0 g).

The mixture was then injection moulded, using an injection moulding machine set to a barrel temperature of 190° C., to form a closure.

On exposure to broadband UV radiation the colourless areas turned green.

A 266 nm, 3 W UV laser linked to an IBM compatible PC was used to write text and draw artwork and devices on the closure.

### Example 2

### Application of an Amine Type CTA to a Thermoplastic Using an Injection Moulding Process

Hastalen ACP5831 D polyethylene (150 g) was mixed with triphenylamime (3 g) and triarylsulphonium hexafluorophosphate salts (50%) mixed in propylene carbonate (2.0 g).

The mixture was then injection moulded, using an injection moulding machine set to a barrel temperature of 190° C., to form a closure.

On exposure to broadband UV radiation the colourless areas turned green.

A 266 nm, 3 W UV laser linked to an IBM compatible PC was used to write text and draw artwork and devices on the closure.

### Example 3

### Application of an Carbazole and Amine Type CTAs to a Thermoplastic Using an Injection Moulding Process

Hastalen ACP5831 D polyethylene (150 g) was mixed with N-ethyl carbazole (1.5 g) and triphenylamine (0.5 g) and triarylsulphonium hexafluorophosphate salts (50%) mixed in propylene carbonate (1.5 g).

The mixture was then injection moulded, using an injection moulding machine set to a barrel temperature of 190° C., to form a closure.

On exposure to broadband UV radiation the colourless areas turned green.

A 266 nm, 3 W UV laser linked to an IBM compatible PC was used to write text and draw artwork and devices on the closure.

### Example 4

### Application of a Polycarbazole Type CTA to a Thermoplastic Using an Injection Moulding Process

Hastalen ACP5831 D polyethylene (150 g) was mixed with poly(vinylcarbazole) (1.5 g) and triphenylamine (0.5 g) and triarylsulphonium hexafluorophosphate salts (50%) mixed in propylene carbonate (1.5 g).

The mixture was then injection moulded, using an injection moulding machine set to a barrel temperature of 190° C., to form a closure.

On exposure to broadband UV radiation the colourless areas turned blue/green.

A 266 nm, 3 W UV laser linked to an IBM compatible PC was used to write text and draw artwork and devices on the closure.

### Example 5

### Application of a Leuco Dye Type CTA to a Thermoplastic Using an Injection Moulding Process

Hastalen ACP5831 D polyethylene (150 g) was mixed with Yamada ETAC (1.5 g) and triphenylamine (0.5 g) and triarylsulphonium hexafluorophosphate salts (50%) mixed in propylene carbonate (1.5 g).

The mixture was then injection moulded, using an injection moulding machine set to a barrel temperature of 190° C., to form a closure.

On exposure to broadband UV radiation the colourless areas turned black.

A 266 nm, 3 W UV laser linked to an IBM compatible PC was used to write text and draw artwork and devices on the closure.

### Example 6

### Application of a Leuco Dye Type CTA to a Thermoplastic Using an Injection Moulding Process

Hastalen ACP5831 D polyethylene (150 g) was mixed with Pergascript Yellow I-3R (1.5 g) and 1-naphthyl diphenyl sulphonium triflate (1.5 g).

The mixture was then injection moulded, using an injection moulding machine set to a barrel temperature of 190° C., to form a closure.

On exposure to broadband UV radiation the colourless areas turned yellow.

A 266 nm, 3 W UV laser linked to an IBM compatible PC was used to write text and draw artwork and devices on the closure.

### Example 7

### Application of a Leuco Dye Type CTA to a Thermoplastic Using an Injection Moulding Process

Borealis RB307MO polypropylene (150 g) was mixed with Yamada ETAC (1.5 g) and 1-naphthyl diphenyl sulphonium triflate (1.5 g).

The mixture was then injection moulded, using an injection moulding machine set to a barrel temperature of 220° C., to form a closure.

On exposure to broadband UV radiation the colourless areas turned green/black.

A 266 nm, 3 W UV laser linked to an IBM compatible PC was used to write text and draw artwork and devices on the closure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Thermoplastic material comprising polymer and at least one charge transfer agent, wherein the charge transfer agent is substantially colourless when neutral, but which develops colour when a charge is acquired, and further comprising a photo acid generating agent.

2. Thermoplastic material according to claim 1, wherein the photo acid generating agent comprises a compound selected from the group consisting of ‘onium’ type compounds, triazine, phthalimide, naphthalimide and carboximide compounds.

3. Thermoplastic material according to claim 2, wherein the photo acid generating agent comprises an iodonium or sulphonium compound.

4. Thermoplastic material according to claim 3, wherein the photo acid generating agent comprises a perfluoro-1-butanesulfonate, p-toluenesulfonate 9,10-dimethoxyanthracene-2-sulfonate, nitrate, triflate or hexafluorophosphate salt of the iodonium or sulphonium compounds.

5. Thermoplastic material according to claim 1 wherein the polymer is a polyolefin selected from polyethylene, polyethylene terephthalate, polypropylene, or mixtures thereof.

6. Thermoplastic material according to claim 1, wherein the charge transfer agent is a compound that comprises at least one nitrogen atom.

7. Thermoplastic material according to claim 6, wherein the charge transfer agent is selected from the group consisting of amines, carbazoles and leuco dyes.

8. Thermoplastic material according to claim 1, wherein the thermoplastic material comprises:
from about 80% to about 99.98% by weight of the polymer;
from about 0.01% to about 10% by weight of the charge transfer agent; and
from about 0.01% to about 10% by weight of the photoacid generating agent.

9. Thermoplastic material according to claim 1, further comprising at least one other substance capable of changing colour upon irradiation.

10. Method of processing thermoplastic material to form a plastic article, wherein the method comprises the step of processing the thermoplastic material at a temperature greater than the melt temperature, Tₘ, of the thermoplastic, wherein the thermoplastic material comprises polymer and at least one charge transfer agent, wherein the charge transfer agent is substantially colourless when neutral, but which develops colour when a charge is acquired, and further comprising a photo acid generating agent selected from the group consisting of sulphonium and iodonium compounds, and wherein the method further comprises the step of irradiating the plastic article to colour at least a region of the plastic article.

11. Method of processing thermoplastic material according to claim 10, wherein the photo acid generating agent comprises a compound selected from the group consisting of ‘onium’ type compounds, triazine, phthalimide, naphthalimide and carboximide compounds.

12. Method of processing thermoplastic material according to claim 11, wherein the photo acid generating agent comprises an iodonium or sulphonium compound.

13. Method of processing thermoplastic material according to claim 12, wherein the photo acid generating agent comprises a perfluoro-1-butanesulfonate, p-toluenesulfonate 9,10-dimethoxyanthracene-2-sulfonate, nitrate, triflate or hexafluorophosphate salt of the iodonium or sulphonium compound.

14. Method of processing thermoplastic material according to claim 10, wherein the polymer is a polyolefin selected from polyethylene, polyethylene terephthalate, polypropylene, or mixtures thereof.

15. Method of processing thermoplastic material according to claim 10, wherein the thermoplastic material comprises:
from about 80% to about 99.98% by weight of the polymer;
from about 0.01% to about 10% by weight of the charge transfer agent; and
from about 0.01% to about 10% by weight of the photoacid generating agent.

16. Method of processing thermoplastic material according to claim 10, wherein the step of processing the plastic comprises blow molding, injection molding, or extrusion.

17. Method of processing thermoplastic material according to claim 10, wherein the thermoplastic material further comprises one or more additives selected from the group consisting of opacifying agents, pearlescent agents, fluorescent agents, radiation absorbers, binders, pigments, dyes, resins, lubricants, solubilizers, particulate materials, and mixtures thereof; preferably opacifying agents, pearlescent agents, fluorescent agents, UV-absorbers, IR-absorbers and mixtures thereof.

18. A method according to claim 10 wherein the step of processing the thermoplastic material is at a temperature between about 100° C. and about 500° C.
